(19) United States
(12) Patent Application Publication
(10) Pub. No.: US 2005/0190322 A1
(43) Pub. Date: Sep. 1, 2005

(54) Etching composition for laminated film including reflective electrode and method for forming laminated wiring structure

(76) Inventors: Satoshi Okabe, Tokyo (JP); Taketo Maruyama, Tokyo (JP); Masafumi Kokura, Mie (JP); Yoshiharu Kataoka, Mie (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/063,607

(22) Filed: Feb. 24, 2005

(30) Foreign Application Priority Data
Feb. 25, 2004 (JP) 2004-049928

(51) Int. Cl. G02F 1/1335

(52) U.S. Cl. 349/113

(57) ABSTRACT

The etching composition of the invention is capable of simultaneously etching the films of a three-layered laminate film comprising an uppermost amorphous transparent electrode film made of IZO, etc., an intermediate reflective electrode film made of Al, etc. and a lowermost galvanic corrosion-inhibiting film made of Mo, etc. or a two-layered laminate film comprising an upper amorphous transparent electrode film and a lower reflective electrode film by a sole use thereof in a single etching operation to provide an etched laminate film having an edge of a good normal-tapered or stepwise shape. The etching composition comprises an aqueous water containing 30 to 40% by weight of phosphoric acid, 15 to 35% by weight of nitric acid, an organic acid and a cation-generating component.

### BACKGROUND OF THE INVENTION

1. Field of the Invention

The present invention relates to a method for forming a laminated wiring structure for use as a signal wiring of liquid crystal displays, etc., and more particularly, relates to a method for forming a highly reliable laminated wiring structure for reflective/transmissive-type liquid crystal displays, which comprises a process of etching a laminated film including a reflective electrode film to produce a reflective/transmissive substrate. The present invention also relates to an etching composition suitably used for etching the laminated film including the reflective electrode film.

2. Description of the Prior Arts

Active matrix-type (AM-type) liquid crystal displays (LCDs), in which transparent pixel electrodes made of ITO (indium tin oxide), IZO (indium zinc oxide), etc. which are arranged in matrix on a glass substrate are driven by TFT (thin film transistor), have now come to dominate in the LCDs because of their low power consumption and high display performance. By a technique of increasing the number of scanning lines, etc., a high resolution of display, a high contrast, a multi-gradation and a large viewing angle are being achieved in the AM-type LCDs. Recently, there is an increased demand for a further reduction in power consumption. Under this circumstance, reflective-type liquid crystal displays and reflective/transmissive-type liquid crystal displays have been extensively developed in place of transmissive-type liquid crystal displays which usually require backlights.

The reflective layer of the reflective-type liquid crystal displays is made of Al or Ag. However, since Ag easily diffuses into an Si layer, a great care must be taken for handling Ag in the manufacture of semiconductors. Therefore, Al is now widely used because Al is unlikely to diffuse to and react with an Si layer and excellent in process properties such as etching properties. However, in the reflective/transmissive-type liquid crystal displays, since the electrode on the color filter side is made of ITO and the transmissive portion is made of ITO and a reflective portion is made of Al, displaying defects such as flicker result because of the difference in work functions of the transmissive portion and the reflective portion. To eliminate such displaying defects, it has been proposed to laminate a transparent conductive material such as ITO and IZO having a similar work function as that of the ITO film which forms the transmissive portion to the Al reflective electrode film (U.S. Pat. No. 5,764,324).

In the reflective/transmissive-type liquid crystal displays including an Al reflective electrode film, ITO films for a transmissive portion and a signal input terminal and an Al reflective electrode film are formed on the same substrate. If the Al reflective electrode film is patterned into a given shape by a photolithographic process using an alkaline developer, the ITO transparent electrode film and the Al reflective electrode film are corroded by a battery effect (galvanic corrosion) to reduce the production yield.

To avoid the galvanic corrosion, there have been proposed a technique in which, before forming an Al reflective electrode film, a film of a metal material such as Mo having a standard electric potential similar to that of ITO is formed to provide a two-layered structure (U.S. Pat. No. 6,184,960). According to this technique, the Mo film and the Al film can be successively formed and the resultant two films can be simultaneously etched with a mixed solution of phosphoric acid, nitric acid, acetic acid and water, thereby enabling the patterning of the Al reflective electrode film without increasing the number of steps and causing the galvanic corrosion.

As described above, the reflective-type liquid crystal displays require a three-layered structure of transparent electrode film/Al film/galvanic corrosion-inhibiting metal film of Mo, etc. If the three-layered structure can be photolithographically etched with a single etching composition in a single operation, the production of liquid crystal displays can be significantly simplified.

The edge shape of the three-layered structure may have an influence on the production yield in the subsequent steps. For example, if the edge is in a shape in which one or both of the transparent electrode film and the Al film outwardly project beyond the galvanic corrosion-inhibiting metal film (reverse taper), or the edge is in a shape in which the transparent electrode film outwardly projects beyond the Al film (overhang taper), the upper film outwardly projecting beyond the lower film is fallen off to form fine dusts during a step for stripping a resist pattern remaining after etching or a cleaning step, thereby causing defects such as short circuit. Namely, the edge of the three-layered film of transparent electrode film/Al film/galvanic corrosion-inhibiting metal film after etching is required to be in a normal-tapered or stepwise shape in which the Al film untowardly projects beyond the transparent electrode film and the galvanic corrosion-inhibiting metal film outwardly projects beyond the Al film. As described below, however, it is technically difficult for the conventional techniques to make the edge of the three-layered structure into the normal-tapered or stepwise shape in a single etching operation using a single etching composition.

It is generally known to use a mixed acid of phosphoric acid, nitric acid and acetic acid as an etching composition for etching a laminated structure including an Al-based metal film. However, it is extremely difficult to make the edge of the three-layered structure into the normal-tapered or stepwise shape with known etching compositions. For example, JP 7-176525A discloses the patterning of an Al or Al-based metal film with an etching composition comprising phosphoric acid, nitric acid, acetic acid and water in a volume ratio of 16:2-8:2:1. However, when a three-layered structure of transparent electrode film (for example, IZO)/reflective electrode film (for example, Al)/galvanic corrosion-inhibiting film (for example, Mo) is etched with the proposed etching composition, the reflective electrode film is selectively etched because of a large content of phosphoric acid so that the upper transparent electrode layer undesirably remains to overhang the lower reflective electrode film. JP 9-127555A proposes an etching composition of a mixed acid comprising phosphoric acid, nitric acid and acetic acid, with acetic acid being the major component. However, since the contents of phosphoric acid and nitric acid which contribute to etching Al and Mo are low, the proposed etching composition requires a long etching time. Therefore, the proposed etching composition is ineffective to etch the three-layered structure of transparent electrode film/reflective electrode film/galvanic corrosion-inhibiting film in a single etching operation. Since phosphoric acid, nitric acid and acetic acid respectively have their own etching properties, etching compositions having a phosphoric acid concentration higher than each of a nitric acid concentration and an acetic acid concentration or having an acetic acid concentration higher than each of a phosphoric acid concentration and a nitric acid concentration are not preferred as described above. If the nitric acid concentration is higher than each of the phosphoric acid concentration and the acetic acid concentration, the edge will be unfavorably made into the reverse-tapered shape because Mo is selectively etched.

The etching compositions proposed in the above prior documents make the edge, in some cases, into a shape in which the uppermost transparent electrode film outwardly projects beyond the lower films, i.e., an overhang shape. In this case, it is possible to make the edge into the stepwise or normal-tapered shape by selectively etching the overhanging transparent electrode film with a liquid which does not etch Al and Mo such as an aqueous solution of oxalic acid. However, such a method increases the number of etching steps and etching apparatuses and is not suitable in view of the production efficiency.

As described above, the conventional etching compositions are merely effective for etching laminate films of Mo/Al, Mo/Al/Mo, etc. so as to make the edge into the stepwise or normal-tapered shape. When different metals, for example, Al and Mo are laminated, the galvanic corrosion occurs during the wet-etching because of the difference of inherent electronegativity between the metals, while the degree of the galvanic corrosion varies depending upon the kinds of metals which form the laminate films. Namely, in the etching compositions directed to etch the Mo/Al laminate film as disclosed in the prior art documents, only the galvanic corrosion between the metals is considered. However, in case of etching laminate films including a transparent electrode film such as IZO, different technical problems which are not addressed in the prior art should be considered.

JP 2003-013261A teaches that Mo/Al or Mo/Al/Mo laminate film can be etched so as to make the edge into a good normal-tapered shape by an aqueous solution containing phosphoric acid (50 to 80% by weight), nitric acid (0.5 to 10% by weight), organic acid (0.5 to 10% by weight) and cation (0.1 to 10% by weight). However, the document describes nothing about the etching of laminate films including the transparent electrode film and considers nothing about the galvanic corrosion between the transparent electrode film and the metal such as Al and Mo.

### SUMMARY OF THE INVENTION

A first object of the present invention is to solve various problems in the prior arts and provide an etching composition which is capable of wet-etching a three-layered laminate film comprising an uppermost amorphous transparent electrode film, an intermediate Al or Al alloy reflective electrode film and a lowermost galvanic corrosion-inhibiting film or a two-layered laminate film comprising an upper amorphous transparent electrode film and a lower Al or Al alloy reflective electrode film so as to provide an edge of a good normal-tapered or stepwise shape in a single etching operation with its sole use. A second object of the present invention is to provide a method of producing a laminated wiring structure which comprises a step of efficiently wet-etching the three or two-layered laminate film with the etching composition so as to provide an edge of a good normal-tapered or stepwise shape. Hereinafter, the Al or Al alloy reflective electrode film may be referred to merely as the Al reflective electrode film.

As a result of extensive research in view of solving the problems in the above prior arts, the inventors have found that an aqueous solution containing 30 to 45% by weight of phosphoric acid, 15 to 35% by weight of nitric acid, an organic acid and a cation-generating component is capable of etching the three or two-layered laminate film so as to provide an edge of a good normal-tapered or stepwise shape in a single etching operation with its sole use. The present invention has been accomplished on the basis of this finding.

Thus, the present invention provides an etching composition comprising an aqueous solution containing 30 to 45% by weight of phosphoric acid, 15 to 35% by weight of nitric acid, an organic acid and a cation-generating component.

The present invention further provides a method of producing a laminated wiring structure which comprises a step of wet-etching a three-layered laminate film comprising an uppermost amorphous transparent electrode film, an intermediate Al or Al alloy reflective electrode film and a lowermost galvanic corrosion-inhibiting film or a two-layered laminate film comprising an upper amorphous transparent electrode film and a lower Al or Al alloy reflective electrode film by a sole use of the etching composition in a single etching operation, thereby simultaneously wet-etching the three layered film or the two layered film so as to make an edge of the laminate film into a normal-tapered or stepwise shape.

The present invention still further provides a substrate for display devices having the laminated wiring structure produced by the above method as a reflective electrode, a liquid crystal display including the substrate for display devices, and production methods thereof.

### BRIEF DESCRIPTION OF THE DRAWINGS

FIG. 1 is a plan view showing a pixel of a reflective/transmissive-type liquid crystal display according to the present invention.

FIG. 2 is a cross-sectional view taken along the line A-A′ of FIG. 1.

FIGS. 3a to 3d are cross-sectional views showing the production steps of the reflective electrode of FIG. 2.

FIG. 4 is a cross-sectional view schematically showing the edge of laminate film having a good normal-tapered or stepwise shape obtained in Examples 1-7.

FIG. 5 is a cross sectional view schematically showing the edge of laminate film obtained in Comparative Example 5.

FIG. 6 is a cross sectional view schematically showing the edge of laminate film obtained in Comparative Example 6.

### PREFERRED EMBODIMENT OF THE INVENTION

The etching composition of the present invention is an aqueous solution containing phosphoric acid, nitric acid, an organic acid and a cation-generating component. The concentration of phosphoric acid in the etching composition is 30 to 45% by weight and preferably 30 to 40% by weight. The phosphoric acid contributes mainly to etching the Al reflective electrode film. If the concentration of phosphoric acid is less than 30% by weight, the etch rate of the Al reflective electrode film becomes low. If exceeding 45% by weight, the etch rate of the Al reflective electrode film becomes too high. Thus, concentrations less than 30% by weight and exceeding 45% by weight are not suitable for forming the edge into the normal-tapered or stepwise shape.

The concentration of nitric acid in the etching composition is 15 to 35% by weight, preferably 20 to 30% by weight. The nitric acid contributes mainly to etching the galvanic corrosion-inhibiting film mainly made of Mo, etc. If the concentration of nitric acid is less than 15% by weight, the etch rate of the galvanic corrosion-inhibiting film becomes low. If exceeding 35% by weight, the etch rate of the galvanic corrosion-inhibiting film becomes too high. Thus, concentrations less than 15% by weight and exceeding 35% by weight are not suitable for forming the edge into the normal-tapered or stepwise shape.

Examples of the organic acid include monocarboxylic acids such as acetic acid, propionic acid and butyric acid; dicarboxylic acids such as oxalic acid, malonic acid, succinic acid, glutaric acid, adipic acid, pimelic acid, maleic acid, fumaric acid and phthalic acid; tricarboxylic acids such as trimellitic acid; oxymonocarboxylic acids such as hydroxyacetic acid, lactic acid and salicylic acid; oxydicarboxylic acids such as malic acid and tartaric acid; oxytricarboxylic acids such as citric acid; and aminocarboxylic acids such as aspartic acid and glutamic acid, with the organic acids having a smaller number of carbon atoms being preferred because organic acids having a larger number of atoms are easily degraded by the oxidation due to nitric acid, the organic acids having 2 to 4 carbon atoms being more preferred, and acetic acid which is generally used as a component for etching compositions being still more preferred because of its easily availability. The organic acid is used mainly to regulate the concentrations of other components of the etching composition within the ranges optimum for exhibiting intended performances (buffer effect). Therefore, the concentration of the organic acid is not particularly limited and determined depending on the concentration of each component and etching conditions, and preferably 2 to 10% by weight in view of buffer effect.

Examples of the cation-generating component include ammonia; quaternary ammonium salts such as tetramethylammonium hydroxide, tetraethylammonium hydroxide and trimethyl(2-hydroxyethyl)ammonium hydroxide; salts of alkali metal such as sodium and potassium; aliphatic amines such as methylamine, dimethylamine, trimethylamine, ethylamine, diethylamine, triethylamine, propylamine, dipropylamine, tripropylamine, butylamine, dibutylamine and tributylamine; alkanol amines such as monoethanolamine, diethanolamine and triethanolamine; polyamines such as ethylenediamine, propylenediamine, trimethylenediamine and tetramethylenediamine; and cyclic amines such as pyrrole, pyrroline, pyrrolidine and morpholine.

In the etching composition, the cation-generating component generates cations such as ammonium ion, ammine complex ions, quaternary ammonium ions and alkali metal ions. Since the metal ions after use likely causes pollution and the organic compounds such as amines may be decomposed by nitric acid, the cation-generating components which generate ammonium ion, ammine complex ions and quaternary ammonium ions are preferred. It is preferred that the cation-generating component is a salt capable of generating such kinds of cations in view of the safe preparation of etching composition.

The cation-generating component is used for controlling the ratio of etch rates between the Al reflective electrode film and the galvanic corrosion-inhibiting film. The generated cations reduce the etch rate of the lower galvanic corrosion-inhibiting film to prevent the overhang of the upper Al reflective electrode film and transparent electrode film. The concentration of the cation-generating component effective for preventing the overhanging is preferably 0.5 to 10% by weight, more preferably 0.5 to 5% by weight in view of the safe preparation of the etching composition, while depending on the concentrations of phosphoric acid and nitric acid. If the concentration of the cation-generating component is less than 0.5% by weight, the lowermost layer (galvanic corrosion-inhibiting film) is selectively etched to allow the upper layers (Al reflective electrode film and transparent electrode film) to overhang. If exceeding 10% by weight, the etch rate of the galvanic corrosion-inhibiting film becomes unduly low to make the etching difficult.

The water content of the etching composition varies depending upon the material of the laminate film to be etched and preferably 20 to 40% by weight.

The transparent electrode film constituting the laminate film to be etched with the etching composition of the present invention is not particularly limited as long as it is amorphous, and usually made of amorphous ITO (a-ITO) and IZO. The Al reflective electrode film is made of Al or Al alloys which are suitably selected from materials generally used for forming reflective electrode films. The galvanic corrosion-inhibiting film is made of molybdenum (Mo), molybdenum nitride (MoN), etc. Examples of the laminate films (uppermost film/intermediate film/lowermost film) to be etched include a-ITO/Al/Mo, a-ITO/Al/MoN, IZO/Al/Mo and IZO/Al/MoN. If a crystalline ITO undercoat film is electrically connected to the laminate film including a galvanic corrosion-inhibiting film made of Mo, the overetching will occur because of the battery effect between Mo and the crystalline ITO. If the Al reflective electrode film is directly and electrically connected to the crystalline ITO film, the corrosion due to the battery effect (galvanic corrosion) will occur between the transparent electrode film and the Al reflective electrode film, as mentioned above. Therefore, in case of electrically connecting a crystalline ITO undercoat film, it is preferred for the laminate film to have a structure of a-ITO/Al/MoN or IZO/Al/MoN.

The MoN film may be relatively easily formed by depositing Mo under Ar gas flow containing N₂ gas. As a result of examining the relationship between the nitrogen content of MoN film and the shape of edge of etched laminate film, it has been found that both are correlated with each other and a higher nitrogen concentration is preferable for controlling the overetching to make the edge into a good normal-tapered shape. The relationships between the nitrogen content of MoN film and the shape of edge after etching are shown in Table 1.

TABLE 1

| | Film-forming | | | | |
|---|---|---|---|---|---|
| | conditions | | Etching | Nitrogen | |
| | Ar | N₂ | time | content | |
| | (sccm) | (sccm) | (s) | (atom %) | Shape of edge |
| 1 | 135 | 0 | — | 0.0 | reverse taper |
| 2 | 135 | 25 | 45 | 7.1 | reverse taper |
| 3 | 135 | 50 | 50 | 10.5 | insufficient normal taper |
| 4 | 135 | 65 | 50 | 17.6 | normal taper |
| 5 | 135 | 80 | 60 | 21.2 | normal taper |
| 6 | 135 | 105 | 80 | 27.2 | normal taper |
| 7 | 135 | 135 | 95 | 33.3 | normal taper |

Laminate films: IZO/Al/MoN/crystalline ITO
Etching composition (% by weight): phosphoric acid/nitric acid/acetic
acid/NH₄OH/water=30/25/5/2/balance
Etching apparatus: shower-type
Etching temperature: 40° C.

If the nitrogen content of MoN film is less than 10 atom %, the edge is reversely tapered to possibly reduce the production yield. A good normal-tapered edge is achieved at a content of 10 atom % or more. Since the just etching time becomes longer with increasing nitrogen content, a nitrogen content exceeding 30 atom % is not preferred in view of the production efficiency. The relationship between the nitrogen content and the shape of edge considerably varies depending upon the etching conditions. The results obtained by laboratory experiments using a simple shower-type etching apparatus are shown in the above table. If the shower etching is conducted by using an industrial production apparatus, a good normal taper is achieved in some cases even at a nitrogen concentration of less than 10 atom %, because the amount of molybdic acid remaining at etching site is reduced by a high pressure of shower. The nitrogen content was measured by an Auger spectroscope “SAM670” available from Perkin-Elmer Inc.

In addition to the three-layered laminate films mentioned above, the films of two-layered laminate film can be collectively etched to have an edge of normal-tapered or stepwise shape by the sole use of the etching composition of the invention in a single etching operation. Examples of the two-layered laminate films (upper film/lower film) are those obtained by removing any one of films from the above three-layered laminate film without changing the vertical stacking order of the remaining two films, such as a-ITO/Al, a-ITO/Mo, a-ITO/MoN, IZO/Al, IZO/Mo, IZO/MoN, Al/Mo and Al/MoN. Since the problem mentioned above likely occurs, it is preferred for the two-layered laminate film to have a structure of a-ITO/MoN, IZO/MoN or Al/MoN in case of electrically connecting a crystalline ITO undercoat film to the laminate film.

The wet-etching using the etching composition of the invention is carried out preferably in a range of room temperature to 70° C. The etching temperature is suitably selected from the above range while taking the kinds of laminate films to be etched, the thickness thereof, etc., and preferably 30 to 50° C. in view of minimizing the loss of the etching composition due to splashed mists, etc.

The etching using the etching composition of the invention is carried out in any manner, for example, in dip manner or shower manner, as long as the used etching composition is uniformly replaced by a flesh etching composition at the site where the etching is proceeding. In the dip manner, it is preferred to allow the etching composition to flow on an inclined substrate from the upper portion, because the etching composition on the surface of substrate is easily replaced by flesh one. In the shower manner, the shower pressure and the pivoting method are suitably determined according to the properties of the etching composition.

An embodiment of the invention is described in more detail below with reference to the attached drawings. However, it should be noted that the following embodiments are only illustrative and not intended to limit the invention thereto.

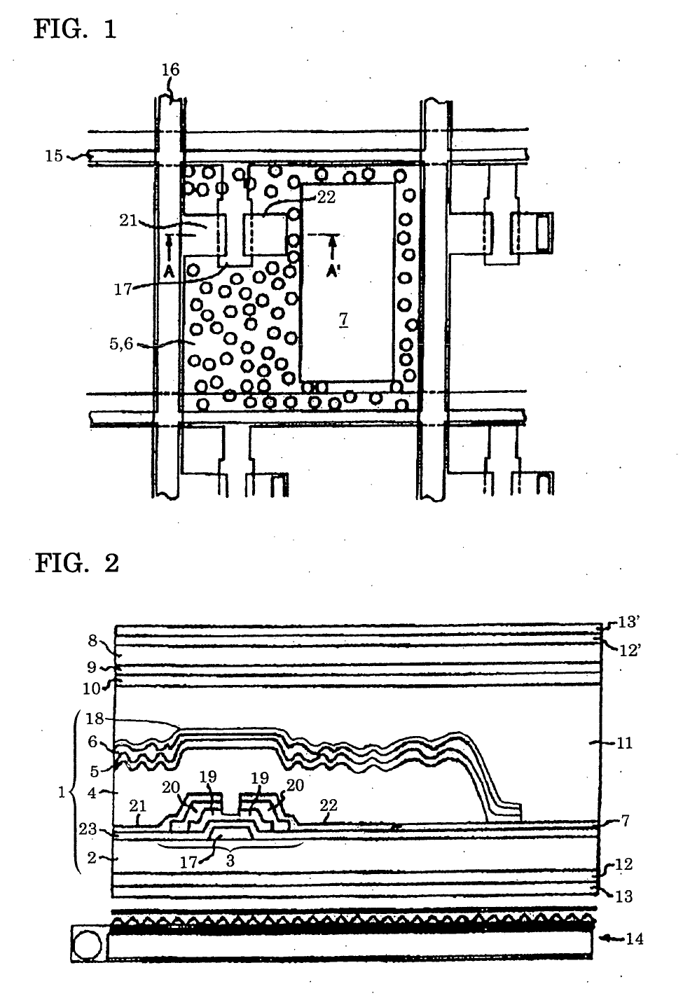

FIG. 1 is a plan view showing a pixel of a reflective/transmissive-type liquid crystal display according to an embodiment of the present invention. FIG. 2 is a cross-sectional view taken along the line A-A′ of FIG. 1.

As shown in FIG. 2, a switching device 3 (TFT) is formed on an insulating substrate 2 (second transmissive substrate). On the insulating substrate 2 provided with the switching device 3, a reflective portion and a transmissive portion are disposed. The reflective portion comprises a laminate which is formed on an interlayer insulator 4 (photosensitive resin) having uneven surface by successively forming a galvanic corrosion-inhibiting film 5 (MoN), a reflective electrode film 6 (Al) and an amorphous transparent electrode film 18 (IZO) in this order. The transmissive portion comprises a transparent electrode film 7 (crystalline ITO). The galvanic corrosion-inhibiting film 5 is a protective film for preventing the galvanic corrosion of the reflective electrode film 6 due to the ITO-Al battery system which is formed together with a developer for use in the photolithographic process. The amorphous transparent electrode film 18 (IZO) is formed for balancing the work functions between the transmissive portion (ITO transparent electrode film 7) and the Al reflective electrode film 6. In this embodiment, the galvanic corrosion-inhibiting film 5 is formed from MoN to allow the laminate comprising the amorphous transparent electrode film 18, the reflective electrode film 6 and the galvanic corrosion-inhibiting film 5 to be etched into the normal-tapered edge. If a good normal-tapered edge is achieved, the galvanic corrosion-inhibiting film 5 may be formed by Mo, but, preferably formed by MoN.

A color filter substrate (first substrate) which is opposed to a transmissive/reflective substrate 1 (second substrate) comprises a glass substrate 8 (first transmissive substrate) and further a color filter layer 9 and a transparent electrode 10 (crystalline ITO) which are successively laminated on the glass substrate 8 in this order. A liquid crystal layer 11 is disposed between the transparent electrode 10 and each of the amorphous transparent electrode film 18 and the transparent electrode film 7. On the outer surface of each of the insulating substrate 2 and the glass substrate 8, a retarder 12, 12′ and a polarizer 13, 13′ are respectively disposed. A backlight 14 is disposed on the outer surface of the polarizer 13. In this embodiment, a polarization mode is employed as the display mode. However, the display mode is not particularly limited thereto. For example, if a guest-host mode is employed, the retarder 12, 12′ and the polarizer 13, 13′ can be omitted.

The reflective/transmissive-type liquid crystal display of this embodiment is explained in more detail below. As shown in FIGS. 1 and 2, the switching device 3 (TFT) is formed on the insulating substrate 2 made of glass, etc. The TFT 3 comprises a gate bus line 15 serving as a scanning signal line which is formed on the insulating substrate 2, a gate electrode 17 (Ta) branched from the gate bus line 15, a gate insulating film 23 (SiNx), a semiconductor film 19 (a-Si), an n-type semiconductor film 20 (n-type a-Si), a source bus line 16, a source electrode 21 branched from the source bus line 16 (Ta/ITO laminate), and a drain electrode 22 (Ta/ITO laminate). The extended portion (transparent electrode 7) of the drain electrode 22 is made of ITO only and functions as a transparent electrode for constituting a part of pixel electrode. The amorphous transparent electrode film 18 and the reflective electrode film 6 which constitute the pixel electrode are electrically connected to the drain electrode 22 through the galvanic corrosion-inhibiting film 5 (MoN) and contact holes (not shown).

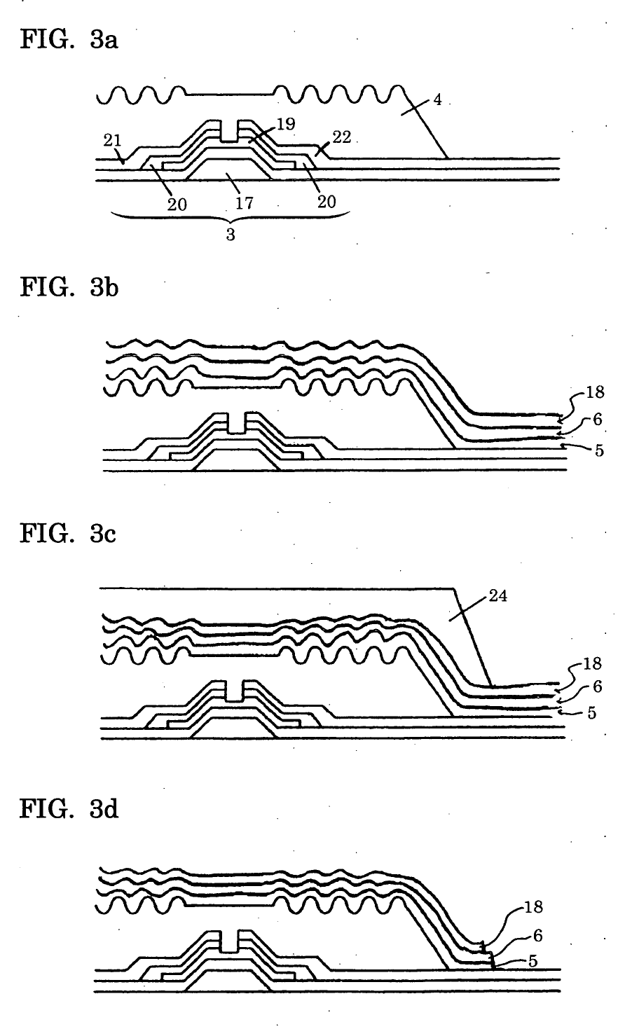

Next, the production of the laminated wiring structure including a reflective electrode (IZO/Al/MoN) is explained with reference to FIGS. 3a to 3d. FIGS. 3a to 3d show a flow for producing the reflective electrode (IZO/Al/MoN).

After forming the TFT 3 on the insulating substrate 2, the interlayer insulator 4 (photosensitive resin) was formed on the TFT 3 (FIG. 3a). Then, the galvanic corrosion-inhibiting film 5 (MoN), the reflective electrode film 6 (Al) and the amorphous transparent electrode film 18 (IZO) were deposited in this order to form the laminate film IZO/Al/MoN (FIG. 3b). The thickness of the amorphous transparent electrode film 18 is preferably 50 to 150 Å. If less than 50 Å, the effect of IZO cannot be obtained stably. If exceeding 150 Å, the reflective electrode is colored yellow because of yellowness of IZO and the etching requires a prolonged period of time. The thickness of the galvanic corrosion-inhibiting film 5 is preferably 500 to 1000 Å, and the thickness of the reflective electrode film 6 is preferably 500 to 1500 Å. In this embodiment, the reflective electrode film 6 was 1000 Å thick and the galvanic corrosion-inhibiting film 5 was 750 Å thick. On the laminate film, a resist 24 was applied and patterned photolithographically (FIG. 3c). In this step, the applied resist 24 was exposed to light while shielding a portion for forming the reflective electrode by a mask and developed into the resist pattern. Finally, the laminate film was etched in a single-wafer processing in manners as will be described in the following examples to form the reflective electrode IZO/Al/MoN (FIG. 3d).

Although the embodiment of the invention is explained by the array substrate for liquid crystal displays as an example, the invention is applicable to the production of wiring substrates for other applications such as array substrates for organic EL devices.

### EXAMPLES 1-7 AND COMPARATIVE EXAMPLES 1-4

After forming a resist pattern on the laminate film IZO/Al/MoN as described above, the wet-etching was conducted using each etching composition listed in Tables 2 and 3 under the following conditions.
Etching apparatus: shower-type
Etching temperature: 40° C.
Etching time: 120 s (30% overetch time)

After etching, the remaining resist pattern was removed by stripping treatment and the resultant substrate was washed with water, dried and observed under an electron microscope (SEM) for the edge shape of the laminate film. The results are shown in Tables 2 and 3.

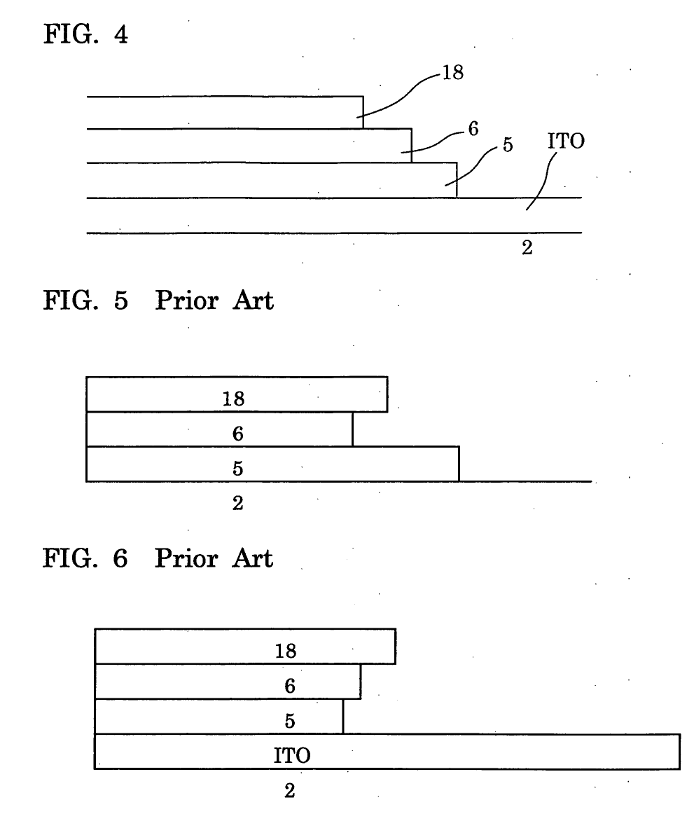

A laminate film (IZO/Al/MoN) having an edge of good normal-tapered or stepwise shape as shown in FIG. 4 was obtained when the etching composition of the invention was used (Examples 1-7), whereas the etching composition which did not satisfy the formulation required in the invention failed to provide a laminate film having an edge of good normal-tapered or stepwise shape.

### COMPARATIVE EXAMPLES 5-6

The above procedure was repeated except for etching a IZO/Al/Mo/insulating film laminate (Comparative Example 5) or a IZO/Al/Mo/ITO laminate (Comparative Example 6) using etching compositions disclosed in JP 2003-013261A. The edge shapes of the resultant laminate films are shown in FIG. 5 (overhanging shape) for Comparative Example 5 and 6 (reverse-taperea shape) for Comparative Example 6.

TABLE 2

| | Examples | | | | | | |
|---|---|---|---|---|---|---|---|
| Formulation (wt %) | 1 | 2 | 3 | 4 | 5 | 6 | 7 |
| Phosphoric acid | 30 | 40 | 30 | 30 | 30 | 40 | 40 |
| Nitric acid | 30 | 30 | 25 | 25 | 25 | 20 | 20 |
| Organic acid | | | | | | | |
| acetic acid | 5 | 5 | 5 | 5 | 5 | 5 | 10 |
| Cation-generating component | | | | | | | |
| ammonium hydroxide | 2 | 2 | 0.5 | 2 | 5 | 5 | 5 |
| Water | 33 | 23 | 39.5 | 38 | 35 | 30 | 25 |
| Edge shape after etching | A | A | A | A | A | A | A |

A: Good normal-tapered or stepwise edge shape shown in FIG. 4.

TABLE 3

| | Comparative Examples | | | | | |
|---|---|---|---|---|---|---|
| Formulation (wt %) | 1 | 2 | 3 | 4 | 5 | 6 |
| Phosphoric acid | 55 | 50 | 50 | 50 | 65 | 65 |
| Nitric acid | 8 | 20 | 20 | 20 | 7 | 7 |
| Organic acid | | | | | | |
| acetic acid | 0 | 5 | 5 | 10 | 5 | 5 |
| Cation-generating component | | | | | | |
| ammonium hydroxide | 2 | 0.5 | 5 | 5 | 1 | 1 |
| Water | 35 | 24.5 | 20 | 15 | 22 | 22 |
| Edge shape after etching | B | C | C | C | | |

B: Overhanging edge shape.
C: Reverse-tapered edge shape.

As described above, the etching composition of the present invention is capable of simultaneously etching the films of a three-layered laminate film comprising an uppermost amorphous transparent electrode film, an intermediate Al or Al alloy reflective electrode film and a lowermost galvanic corrosion-inhibiting film or a two-layered laminate film comprising an upper amorphous transparent electrode film and a lower Al or Al alloy reflective electrode film, such as IZO/Al/MoN and IZO/Al, so as to provide an edge having a normal-tapered or stepwise shape in a single etching operation with its sole use. By the use of the etching composition of the present invention, a reflective/transmissive-type liquid crystal display is produced with a high production efficiency.

1. An etching composition for use in wet-etching a three-layered laminate film comprising an uppermost amorphous transparent electrode film, an intermediate Al or Al alloy reflective electrode film and a lowermost galvanic corrosion-inhibiting film or a two-layered laminate film comprising an upper amorphous transparent electrode film and a lower Al or Al alloy reflective electrode film, said etching composition comprising an aqueous solution containing 30 to 45% by weight of phosphoric acid, 15 to 35% by weight of nitric acid, an organic acid and a cation-generating component.

2. The etching composition according to claim 1, wherein the cation-generating component generates at least one cation selected from the group consisting of ammonium ion, ammine complex ions, quaternary ammonium ions and alkali metal ions in the etching composition, and a concentration thereof is 0.5 to 5% by weight.

3. A method of producing a laminated wiring structure which comprises a step of wet-etching the three-layered film or the two-layered laminate film as defined in claim 1 by a sole use of the etching composition as defined in claim 1 in a single etching operation, thereby simultaneously wet-etching the films of the three layered film or the two layered film so as to make an edge of the laminate film into a normal-tapered or stepwise shape.

4. The method according to claim 3, wherein the galvanic corrosion-inhibiting film is electrically connected directly to a crystalline indium tin oxide.

5. The method according to claim 3, wherein the amorphous transparent electrode is made of amorphous indium tin oxide or indium zinc oxide.

6. The method according to claim 3, wherein the galvanic corrosion-inhibiting film comprises molybdenum or molybdenum nitride.

7. The method according to claim 4, wherein the crystalline indium tin oxide forms an undercoat film of the three-layered laminate film and the galvanic corrosion-inhibiting film comprises molybdenum nitride.

8. The method according to claim 6, wherein a nitrogen content of molybdenum nitride is 10 atom % or higher.

9. A liquid crystal display comprising a first substrate including a first transmissive substrate and a transparent electrode, a second substrate including a second transmissive substrate on which a switching device, an interlayer insulating film and a reflective electrode are disposed in this order, and a liquid crystal layer interposed between the first substrate and the second substrate,
wherein the reflective electrode is a three-layered laminate film comprising an uppermost amorphous transparent electrode film, an intermediate Al or Al alloy reflective electrode film and a lowermost galvanic corrosion-inhibiting film or a two-layered laminate film comprising an upper amorphous transparent electrode film and a lower Al or Al alloy reflective electrode film; and an edge of the three-layered laminate film or the two-layered laminate film is in a normal-tapered or stepwise shape.

10. The liquid crystal display according to claim 9, wherein the normal-tapered or stepwise edge of the three-layered laminate film or the two-layered laminate film is formed by wet-etching the three-layered film or the two-layered laminate film by a sole use of the etching composition as defined in claim 1 in a single etching operation.

11. A method of producing the liquid crystal display as defined in claim 9, comprising a step of wet-etching the three-layered film or the two-layered laminate film by a sole use of the etching composition as defined in claim 1 in a single etching operation.

12. A substrate for display devices comprising a transmissive substrate on which a switching device, an interlayer insulating film and a reflective electrode are disposed in this order,
wherein the reflective electrode is a three-layered laminate film comprising an uppermost amorphous transparent electrode film, an intermediate Al or Al alloy reflective electrode film and a lowermost galvanic corrosion-inhibiting film or a two-layered laminate film comprising an upper amorphous transparent electrode film and a lower Al or Al alloy reflective electrode film; and an edge of the three-layered laminate film or the two-layered laminate film is in a normal-tapered or stepwise shape.

13. The substrate for display devices according to claim 12, wherein the normal-tapered or stepwise edge of the three-layered laminate film or the two-layered laminate film is formed by wet-etching the three-layered film or the two-layered laminate film by a sole use of the etching composition as defined in claim 1 in a single etching operation.

14. A method of producing the substrate for display devices as defined in claim 12, comprising a step of wet-etching the three-layered film or the two-layered laminate film by a sole use of the etching composition as defined in claim 1 in a single etching operation.
